(19) United States
(12) Patent Application Publication
(10) Pub. No.: US 2008/0168635 A1
(43) Pub. Date: Jul. 17, 2008

(54) METHOD FOR REVERSIBLY ATTACHING ARTICLES TO HEADSTONES

(76) Inventor: Melody Chastain, Loveland, CO (US)

Correspondence Address: COCHRAN FREUND & YOUNG LLC, 2026 CARIBOU DR, SUITE 201, FORT COLLINS, CO, 80525, US

(21) Appl. No.: 11/623,577

(22) Filed: Jan. 16, 2007

(51) Int. Cl. E04H 13/00; B29C 65/70; B29C 65/48

(52) U.S. Cl. 27/1; 156/242; 156/325

(57) ABSTRACT

A method for reversibly attaching plastic decorations or other articles to upright or horizontally disposed headstones is described. A commercially available adhesive putty has been found to be effective for attaching polymer composite resin-encapsulated decorations or articles to granite, marble and bronze areas on headstones, or to any other stone material used in headstone manufacture, located out of doors and exposed to snow, rain, hail, wind, and sun, at temperatures exceeding 100° F. as well as at subzero temperatures, whereas removal of the decoration or article for headstone maintenance, replacement or substitution, as examples, will not mar or otherwise damage the surfaces. The adhesive putty may be reworked and reused subsequent to removal of the article from the headstone.

### FIELD OF THE INVENTION

The present invention relates generally to the use of adhesives for joining articles and, more particularly, to the use of adhesives for reversibly attaching resin polymer-encapsulated articles to headstones without marring or staining the surface of the headstone when an article is removed.

### BACKGROUND OF THE INVENTION

For many years, decorations of many types have been attached to the surface of gravestones or headstones by friends and relatives of the deceased. Surfaces include granite, marble and bronze, as examples. The problem with such practices is that the decorations either fall from the headstone as a result of outdoor conditions adversely affecting the adhesive, or bind sufficiently strongly to the surface that the stone is marred when they are removed. One might wish to remove decorations to replace those which have been damaged or have become worn, to provide the stone with a fresh look, and/or in order to allow the stone to be cleaned or otherwise maintained.

Accordingly, it is an object of the present invention to provide a method for attaching articles to headstones which can survive the rigors of outdoor placement while being removable without marring the surface of the headstone.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects, and in accordance with the purposes of the present invention, as embodied and broadly described herein, the method for reversibly attaching an article to a surface of a headstone without marring the surface of the headstone when the article is removed therefrom, hereof, includes the steps of: encapsulating the article in a polymeric composite resin material; placing a chosen quantity of adhesive putty available under the trademark Quake Secure® on a surface of the encapsulated article; and pressing the adhesive putty between the encapsulated article and the headstone.

In another aspect of the invention in accordance with its objects and purposes, the method for reversibly attaching an article to a surface of a headstone without marring the surface of the headstone when the article is removed therefrom, hereof, includes the steps of: encapsulating the article in a polymeric composite resin material by the method including: mixing two parts of Part A of MAX CLR A/B with one part of Part B thereof by weight or by volume, forming thereby a curing mixture; adding an effective amount of the curing mixture to cover the article to a mold containing the article; permitting the mixture to cure for 24-36 h; and removing encapsulated article from the mold; placing a chosen quantity of adhesive putty available under the trademark Quake Secure® on a surface of the encapsulated article; and pressing the adhesive putty between the encapsulated article and the headstone.

In yet another aspect of the invention, in accordance with its objects and purposes, the method for reversibly attaching an article to a surface of a headstone without marring the surface of the headstone when the article is removed therefrom, hereof, includes the steps of: encapsulating the article in a polymeric composite resin material by the method including mixing 2 parts of a mixture including: (Chloromethyl) Oxirane, 4,4′-(1-Methylethylidene) Bisphenol Copolymer with 1 part of a mixture comprising: 25-55% Benzyl alcohol and 15-35% of Isophoronediamine, by weight or by volume, forming thereby a curing mixture; adding an effective amount of the curing mixture to cover the article to a mold containing the article; permitting the mixture to cure for 24-36 h; and removing encapsulated article from the mold; placing a chosen quantity of adhesive putty available under the trademark Quake Secure® on a surface of the encapsulated article; and pressing the adhesive puffy between the encapsulated article and the headstone.

Benefits and advantages of the present invention include, but are not limited to, providing a method for attaching a decorative or other article to a surface a headstone which is sufficiently robust to withstand the rigors of outdoor deployment, while being able to remove the article without marring or otherwise damaging the surface.

### DETAILED DESCRIPTION OF THE INVENTION

Briefly, the present invention includes a method for reversibly attaching plastic decorations or other articles to upright or horizontally disposed headstones. An adhesive putty has been found to be effective for attaching polymer composite resin-encapsulated decorations or other articles to granite, marble and bronze areas of headstones, or to any other stone material used in headstone manufacture, located out of doors and exposed to snow, rain, hail, wind, and sun, at temperatures exceeding 100° F. as well as at subzero temperatures, whereas removal of the decoration or article for headstone maintenance, replacement or substitution, as examples, will not mar or otherwise damage the surfaces. The decorations or other articles have further been found to adhere to the stone during cemetery maintenance, such as mowing over horizontally disposed gravestones. The present invention is also useful reversibly attaching articles to ceramic tile and brick exposed to similar weather conditions. Removal of the decoration will likewise not mar or otherwise damage these surfaces.

Reference will now be made in detail to the present embodiments of the invention. A commercially available two-part polymeric resin mixture is used to encapsulate decorations or other articles which articles may include various shapes and designs including pictures, religious and patriotic symbols, flowers, animals, and sayings, as examples. A small quantity of the adhesive putty is applied to the back portion of the decoration which is then pressed against a portion of the headstone surface, thereby forming a bond between the decoration and the headstone. Typically, the encapsulated articles weigh between 1 and 4 oz, are between ¼″ and ¾″ thick, and may have a flattened back surface to which the adhesive is applied. When the article is to be removed, it is simply twisted or pulled from the surface of the headstone without marring or otherwise damaging this surface. The adhesive putty may remain attached to the resin-encapsulated article or some or all may remain on the headstone; in the latter situation the putty can be removed from the headstone without damage thereto. Generally, the putty may be reworked and reused after removal thereof from the encapsulated article or from the headstone.

Having generally described the present apparatus and method, additional details thereof are described in the following EXAMPLE.

### EXAMPLE

A. Preparation of Articles:

Articles or decorations are prepared by pouring a polymer composite resin mixed with an appropriate catalyst into a mold or vessel containing the article. One resin found to be effective is supplied by Polymer Composites, Inc., 1871 Lake Place, Ontario, Calif. 91761, under the name MAX CLR A/B. Part A of this resin is defined to be in the modified bisphenol epoxy resin chemical family and includes: 90-100% of (Chloromethyl) Oxirane, 4,4′-(1-Methylethylidene) Bisphenol Copolymer (CAS No. 25068-38-6); 1-20% of a proprietary Epoxidize Diluent; 0-10% of a proprietary modified Glycider ether; and 0.1-0.5% of a proprietary non-silicone additive. Part B is defined to be in the amine modified curing agent chemical family and includes: 25-55% Benzyl alcohol (CAS No. 100-51-6); and 15-35% Isophoronediamine (CAS No. 2855-13-2). Two parts of resin and one part of curing agent by either weight or volume were added to a clean, silicone mold containing the article to be encapsulated, in an amount effective for covering the article, and the mixture was permitted to cure for 24-36 h before handling. The silicone mold may include a flat portion to the back portion of the article to be encapsulated such that the portion thereof intended to face the headstone has an increased area for application of the adhesive material. Rigid, clear plastic molds generally used for making soap have also been successfully used.

B. Attachment to Headstones:

Although several adhesives were tested (for example, 3M Company repositionable tapes 665, 9425 and 9425 HT were tried but could not withstand the high and low temperatures), an adhesive putty sold under the Trademark Quake Secure® and marketed by Sunset Enterprises, Ltd., 260 Marjori Ave., Thousand Oaks, Calif. 91320 was found to have the desired properties. This adhesive material includes: 55-65% limestone; 15-25% talc; 7-17% butylene polymers; 5-10% petroleum hydrocarbons; 1-5% titanium dioxide; and 1-2% unsaturated fatty acids. A between about ⅛ and ¼ in. diameter ball of putty was applied to the back of the encapsulated article which was then firmly pressed against the headstone. As stated, the encapsulated decoration or article may be removed when desired without marring or otherwise scarring the headstone, and may be reused repeatedly, while withstanding inclement weather and cemetery maintenance procedures without separating from the headstone.

C. Testing:

Tests for the Quake Secure® adhesive putty included approximately 3 months at 100° F. and about 1 month at −10° F., under conditions including rain and snow, respectively.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for reversibly attaching an article to a surface of a headstone without marring the surface of the headstone when said article is removed therefrom, comprising the steps of:
encapsulating said article in a polymeric composite resin material;
placing a chosen quantity of adhesive putty available under the trademark Quake Secure® on a surface of the encapsulated article;
and pressing the adhesive putty between the encapsulated article and the headstone.

2. The method of claim 1, wherein said step of encapsulating comprises the steps of:
mixing 2 parts of a mixture comprising: (Chloromethyl) Oxirane, 4,4′-(1-Methylethylidene) Bisphenol Copolymer with 1 part of a mixture comprising: 25-55% Benzyl alcohol and 15-35% of Isophoronediamine, by weight or by volume, forming thereby a curing mixture;
adding an effective amount of the curing mixture to cover said article to a mold containing said article;
permitting the mixture to cure for 24-36 h; and
removing encapsulated article from the mold.

3. The method of claim 1, wherein said step of encapsulating comprises the steps of:
mixing two parts of Part A of MAX CLR A/B with one part of Part B thereof by weight or by volume, forming thereby a curing mixture;
adding an effective amount of the curing mixture to cover said article to a mold containing said article; permitting the mixture to cure for 24-36 h; and
removing encapsulated article from the mold.

4. The method of claim 1, wherein the mold comprises a silicone mold.

5. The method of claim 1, wherein the surface of the headstone on which said article is attached is selected from the group consisting of granite, marble and bronze.

6. The method of claim 1, wherein the surface of the encapsulated article on which the adhesive putty is placed is a flat surface.

7. A method for reversibly attaching an article to a surface of a headstone without marring the surface of the headstone when said article is removed therefrom, comprising the steps of:
encapsulating said article in a polymeric composite resin material by the method comprising: mixing two parts of Part A of MAX CLR A/B with one part of Part B thereof by weight or by volume, forming thereby a curing mixture;
adding an effective amount of the curing mixture to cover said article to a mold containing said article;
permitting the mixture to cure for 24-36 h;
removing encapsulated article from the mold;
placing a chosen quantity of adhesive putty available under the trademark Quake Secure® on a surface of the encapsulated article; and
pressing the adhesive putty between the encapsulated article and the headstone.

8. The method of claim 6, wherein the mold comprises a silicone mold.

9. The method of claim 6, wherein the surface of the headstone on which said article is attached is selected from the group consisting of granite, marble and bronze.

10. The method of claim 6, wherein the surface of the encapsulated article on which the adhesive putty is placed is a flat surface.

11. A method for reversibly attaching an article to a surface of a headstone without marring the surface of the headstone when said article is removed therefrom, comprising the steps of:
encapsulating said article in a polymeric composite resin material by the method comprising: mixing 2 parts of a mixture comprising: (Chloromethyl) Oxirane, 4,4′-(1-Methylethylidene) Bisphenol Copolymer with 1 part of a mixture comprising: 25-55% Benzyl alcohol and 15-35% of Isophoronediamine, by weight or by volume, forming thereby a curing mixture;
adding an effective amount of the curing mixture to cover said article to a mold containing said article;
permitting the mixture to cure for 24-36 h;
removing encapsulated article from the mold;
placing a chosen quantity of adhesive putty available under the trademark Quake Secure® on a surface of the encapsulated article; and
pressing the adhesive putty between the encapsulated article and the headstone.

12. The method of claim 9, wherein the mold comprises a silicone mold.

13. The method of claim 9, wherein the surface of the headstone on which said article is attached is selected from the group consisting of granite, marble and bronze.

14. The method of claim 9, wherein the surface of the encapsulated article on which the adhesive putty is placed is a flat surface.
